(19) United States
(12) Patent Application Publication
(10) Pub. No.: US 2025/0250034 A1
(43) Pub. Date: Aug. 7, 2025

(54) QUICK ATTACHMENT SYSTEM

(71) Applicant: MAVRIK, Inc., Charlotte, NC (US)

(72) Inventor: Maxwell Holloway Owens, Charlotte, NC (US)

(21) Appl. No.: 19/045,273

(22) Filed: Feb. 4, 2025

Related U.S. Application Data
(60) Provisional application No. 63/549,756, filed on Feb. 5, 2024.

(51) Int. Cl. B64U 20/00; B64U 20/80

(52) U.S. Cl. CPC B64U 20/00; B64U 20/80

(57) ABSTRACT

A quick-connection assembly including: a first mechanical connector portion configured to be coupled to a portion of an unmanned aerial vehicle; a second mechanical connector portion configured to be coupled to an unmanned aerial vehicle accessory; wherein the first mechanical connector portion and the second mechanical connector portion are configured to be releasably mechanically couplable, thus enabling the unmanned aerial vehicle accessory to be releasably mechanically attachable to the unmanned aerial vehicle.

### RELATED APPLICATION(S)

This application claims the benefit of U.S. Provisional Application No. 63/549,756, filed on 5 Feb. 2024, the entire contents of which are incorporated herein by reference.

### TECHNICAL FIELD

This disclosure relates to unmanned aerial vehicles and, more particularly, to systems for attaching accessories to these unmanned aerial vehicles.

### BACKGROUND

The history of unmanned aerial vehicles (UAVs), also known as drones, spans over a century and reflects significant advancements in technology and diverse applications across military, industrial, and commercial sectors. The early origins of UAVs date back to the 1930s, when Dr. Paul M. O'Neill developed the Radioplane, the first radio-controlled aircraft designed for military target practice. This early innovation laid the foundation for the use of UAVs in training, particularly for anti-aircraft gunnery. During World War II, the U.S. military further experimented with UAVs for reconnaissance and surveillance, and by the Cold War, UAVs were increasingly used for intelligence gathering and military missions. In the 1950s and 1960s, the Ryan Firebee became one of the first operational UAVs, marking a key milestone in their military application.

In the late 20th century, UAV technology saw significant progress due to advancements in GPS systems, autopilot control, and miniaturization of electronics. This allowed UAVs to perform more complex tasks, including long-range surveillance, reconnaissance, and even combat missions. By the early 2000s, UAVs became an integral part of modern military operations, exemplified by systems like the MQ-9 Reaper, which not only provided surveillance but also carried out targeted strikes. Around the same time, civilian drone technology began to emerge, with improved battery life, camera systems, and flight stability, which led to their use in areas such as aerial photography, agriculture, and environmental monitoring.

Today, UAVs perform an incredible range of tasks across various sectors. In the military, they are primarily used for reconnaissance, surveillance, target acquisition, and combat support, allowing for missions without endangering human pilots. In civilian applications, drones are used for tasks such as aerial photography, providing stunning visuals for media and entertainment, and in agriculture, where they are employed for precision farming, including crop monitoring and pest control. Search and rescue operations have greatly benefited from drones equipped with thermal cameras to locate missing persons in hazardous environments. UAVs are also used in delivery services, providing fast and efficient transportation of goods, especially in remote areas. Additionally, infrastructure inspection, environmental monitoring, and disaster relief are areas where UAVs excel, as they can access hard-to-reach locations and provide real-time data, enhancing decision-making and response times.

The development of UAVs has dramatically transformed industries, enabling more efficient operations and safer methods for conducting various tasks. As technology continues to advance, UAVs are expected to play an even larger role in fields such as autonomous delivery, air traffic management, and telecommunications, opening new possibilities for both commercial and military applications. The history of UAVs demonstrates the continuous evolution of these versatile machines, which are now indispensable tools for modern industries and governments alike.

### SUMMARY OF DISCLOSURE

In one implementation, a quick-connection assembly includes: a first mechanical connector portion configured to be coupled to a portion of an unmanned aerial vehicle; a second mechanical connector portion configured to be coupled to an unmanned aerial vehicle accessory; wherein the first mechanical connector portion and the second mechanical connector portion are configured to be releasably mechanically couplable, thus enabling the unmanned aerial vehicle accessory to be releasably mechanically attachable to the unmanned aerial vehicle.

One or more of the following features may be included. The first mechanical connector portion may be configured to be coupled to a panel assembly of the unmanned aerial vehicle. The first mechanical connector portion may be configured to be coupled to a frame assembly of the unmanned aerial vehicle. The first mechanical connector portion and/or the second mechanical connector portion may include one or more of: a hook and latch system; a magnetic fastener system; a suction cup mount system; a clamp and grip fastener system; a quick-release pin/fastener system; a rail and track mounting system; a threaded and bolt-on bracket system; and an interlocking/snap-fit system. The first mechanical connector portion and the second mechanical connector portion may be remotely decouplable. The unmanned aerial vehicle accessory may be configured to utilized for one or more of: high voltage power line maintenance; firefighting; disaster relief; park-and-takeoff intelligence, surveillance, and reconnaissance; construction; contested logistics; agricultural spraying; personnel deployment; casualty evacuation; medical evacuation; drone swarm deployment; robotic systems testing; infrared/camera reconnaissance; anti-drone lasers; target lasing; and RF jamming. The unmanned aerial vehicle accessory may include one or more of: a visible light camera; a thermal imaging camera; a lighting system; a weapon system; a laser system; a cargo bin/net; a cable-based deployment system; a rescue basket; a plurality of swarm drones; a fire retardant deployment system; and an aerosol discharge system. A first electrical connector portion may be configured to be coupled to the portion of the unmanned aerial vehicle. A second electrical connector portion may be configured to be coupled to the unmanned aerial vehicle accessory. The first electrical connector portion and the second electrical connector portion may be configured to be releasably electrically couplable, thus enabling the unmanned aerial vehicle accessory to be releasably electrically attachable to the unmanned aerial vehicle. The first electrical connector portion and/or the second electrical connector portion may be configured to provide electrical power to the unmanned aerial vehicle accessory. The first electrical connector portion and/or the second electrical connector portion may be configured to provide one or more control signals to the unmanned aerial vehicle accessory. The first electrical connector portion and/or the second electrical connector portion may include one or more of: a JST GH connector; a QS8 connector; a serial bus connector; a parallel bus connector; a USB connector; and an RJ45 connector.

In another implementation, a quick-connection assembly includes: a first mechanical connector portion configured to be coupled to a portion of an unmanned aerial vehicle; a second mechanical connector portion configured to be coupled to an unmanned aerial vehicle accessory, wherein the first mechanical connector portion and the second mechanical connector portion are configured to be releasably mechanically couplable, thus enabling the unmanned aerial vehicle accessory to be releasably mechanically attachable to the unmanned aerial vehicle; and wherein the first mechanical connector portion is configured to be coupled to a panel assembly of the unmanned aerial vehicle.

One or more of the following features may be included. The first mechanical connector portion and/or the second mechanical connector portion may include one or more of: a hook and latch system; a magnetic fastener system; a suction cup mount system; a clamp and grip fastener system; a quick-release pin/fastener system; a rail and track mounting system; a threaded and bolt-on bracket system; and an interlocking/snap-fit system. The first mechanical connector portion and the second mechanical connector portion may be remotely decouplable. The unmanned aerial vehicle accessory may be configured to utilized for one or more of: high voltage power line maintenance; firefighting; disaster relief; park-and-takeoff intelligence, surveillance, and reconnaissance; construction; contested logistics; agricultural spraying; personnel deployment; casualty evacuation; medical evacuation; drone swarm deployment; robotic systems testing; infrared/camera reconnaissance; anti-drone lasers; target lasing; and RF jamming. The unmanned aerial vehicle accessory may include one or more of: a visible light camera; a thermal imaging camera; a lighting system; a weapon system; a laser system; a cargo bin/net; a cable-based deployment system; a rescue basket; a plurality of swarm drones; a fire retardant deployment system; and an aerosol discharge system. A first electrical connector portion may be configured to be coupled to the portion of the unmanned aerial vehicle. A second electrical connector portion may be configured to be coupled to the unmanned aerial vehicle accessory. The first electrical connector portion and the second electrical connector portion may be configured to be releasably electrically couplable, thus enabling the unmanned aerial vehicle accessory to be releasably electrically attachable to the unmanned aerial vehicle. The first electrical connector portion and/or the second electrical connector portion may be configured to provide electrical power to the unmanned aerial vehicle accessory. The first electrical connector portion and/or the second electrical connector portion may be configured to provide one or more control signals to the unmanned aerial vehicle accessory. The first electrical connector portion and/or the second electrical connector portion may include one or more of: a JST GH connector; a QS8 connector; a serial bus connector; a parallel bus connector; a USB connector; and an RJ45 connector.

In another implementation, a quick-connection assembly includes: a first mechanical connector portion configured to be coupled to a portion of an unmanned aerial vehicle; a second mechanical connector portion configured to be coupled to an unmanned aerial vehicle accessory, wherein the first mechanical connector portion and the second mechanical connector portion are configured to be releasably mechanically couplable, thus enabling the unmanned aerial vehicle accessory to be releasably mechanically attachable to the unmanned aerial vehicle; a first electrical connector portion configured to be coupled to the portion of the unmanned aerial vehicle; and a second electrical connector portion configured to be coupled to the unmanned aerial vehicle accessory, wherein the first electrical connector portion and the second electrical connector portion are configured to be releasably electrically couplable, thus enabling the unmanned aerial vehicle accessory to be releasably electrically attachable to the unmanned aerial vehicle.

One or more of the following features may be included. The first mechanical connector portion may be configured to be coupled to a panel assembly of the unmanned aerial vehicle. The first mechanical connector portion may be configured to be coupled to a frame assembly of the unmanned aerial vehicle. The first mechanical connector portion and/or the second mechanical connector portion may include one or more of: a hook and latch system; a magnetic fastener system; a suction cup mount system; a clamp and grip fastener system; a quick-release pin/fastener system; a rail and track mounting system; a threaded and bolt-on bracket system; and an interlocking/snap-fit system. The first mechanical connector portion and the second mechanical connector portion may be remotely decouplable. The unmanned aerial vehicle accessory may be configured to utilized for one or more of: high voltage power line maintenance; firefighting; disaster relief; park-and-takeoff intelligence, surveillance, and reconnaissance; construction; contested logistics; agricultural spraying; personnel deployment; casualty evacuation; medical evacuation; drone swarm deployment; robotic systems testing; infrared/camera reconnaissance; anti-drone lasers; target lasing; and RF jamming. The unmanned aerial vehicle accessory may include one or more of: a visible light camera; a thermal imaging camera; a lighting system; a weapon system; a laser system; a cargo bin/net; a cable-based deployment system; a rescue basket; a plurality of swarm drones; a fire retardant deployment system; and an aerosol discharge system. The first electrical connector portion and/or the second electrical connector portion may be configured to provide electrical power to the unmanned aerial vehicle accessory. The first electrical connector portion and/or the second electrical connector portion may be configured to provide one or more control signals to the unmanned aerial vehicle accessory. The first electrical connector portion and/or the second electrical connector portion may include one or more of: a JST GH connector; a QS8 connector; a serial bus connector; a parallel bus connector; a USB connector; and an RJ45 connector.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a quick-connection assembly according to an embodiment of the present disclosure; and

FIGS. 2-11 are isometric views of a unmanned aerial vehicle incorporating the quick-connection assembly of FIG. 1 according to an embodiment of the present disclosure.

Like reference symbols in the various drawings indicate like elements.

### DETAILED DESCRIPTION OF THE PREFERRED EMBODIMENTS

### System Overview

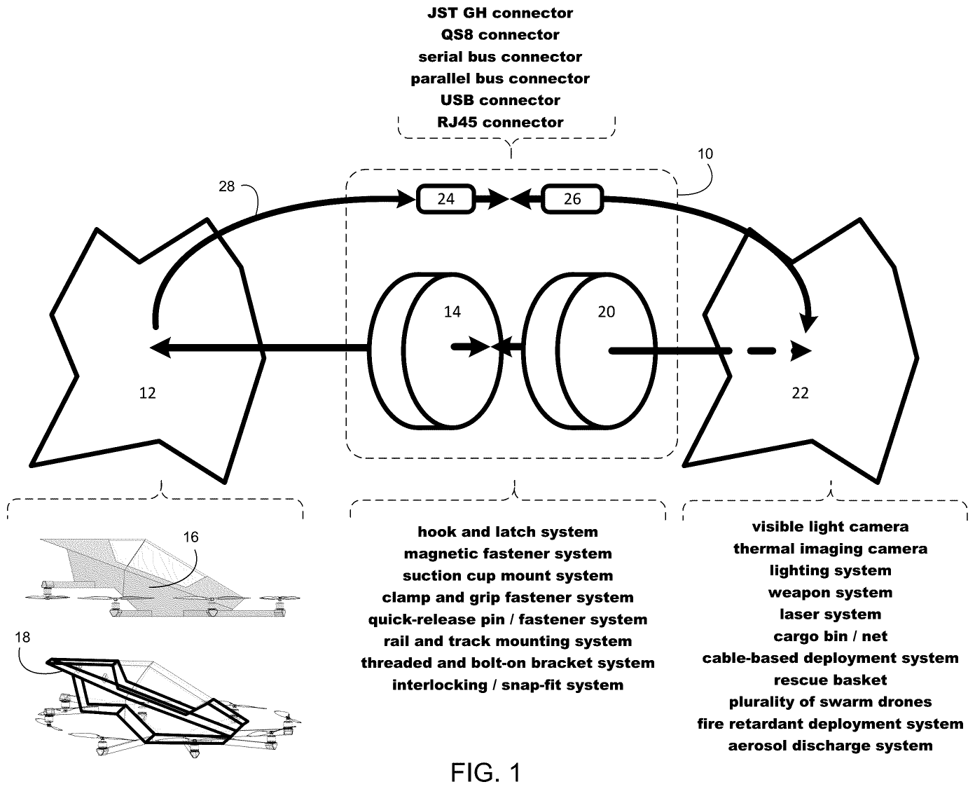

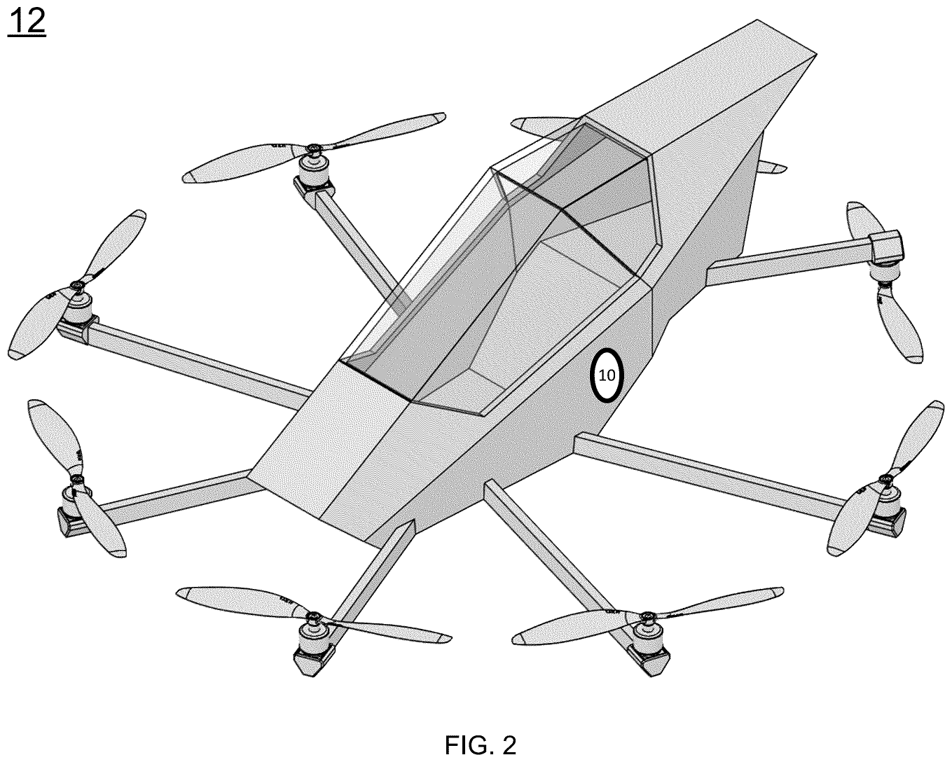

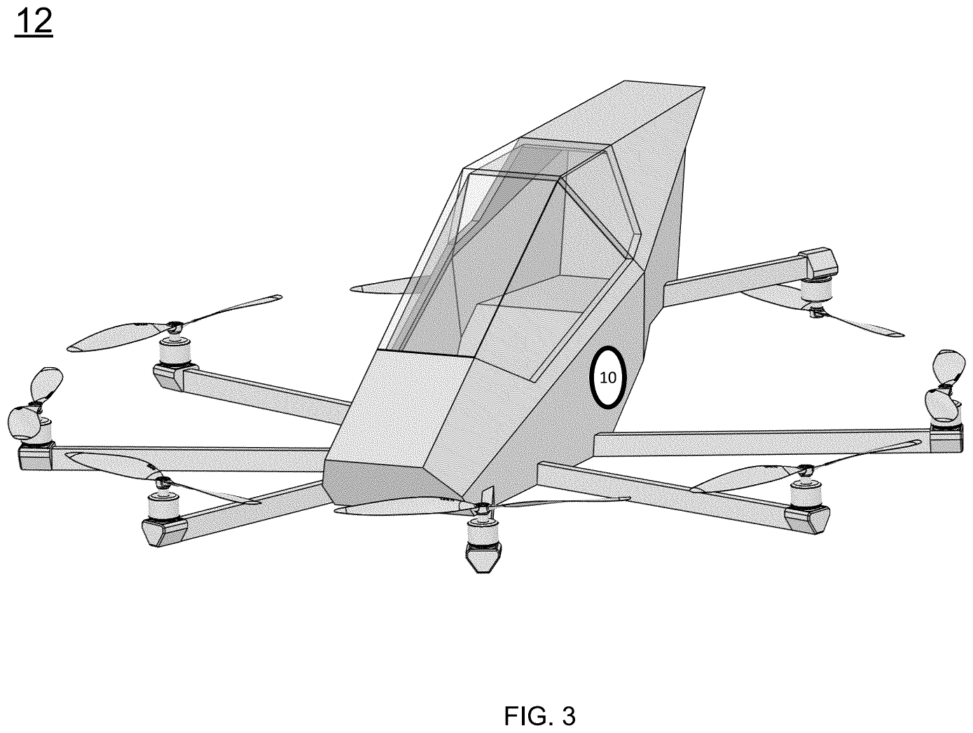

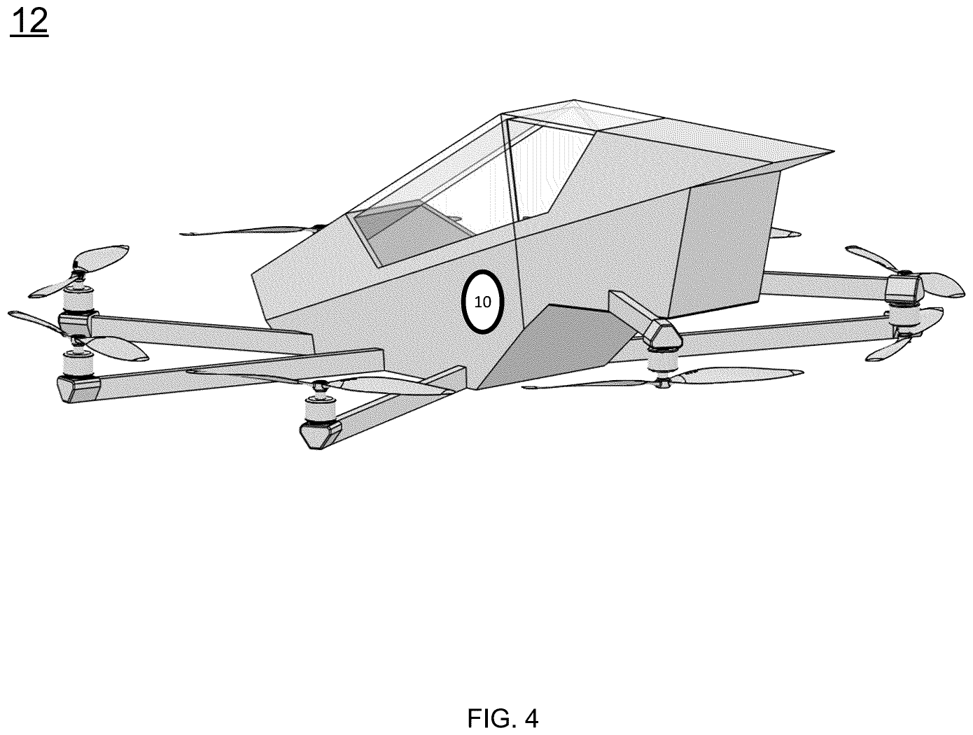

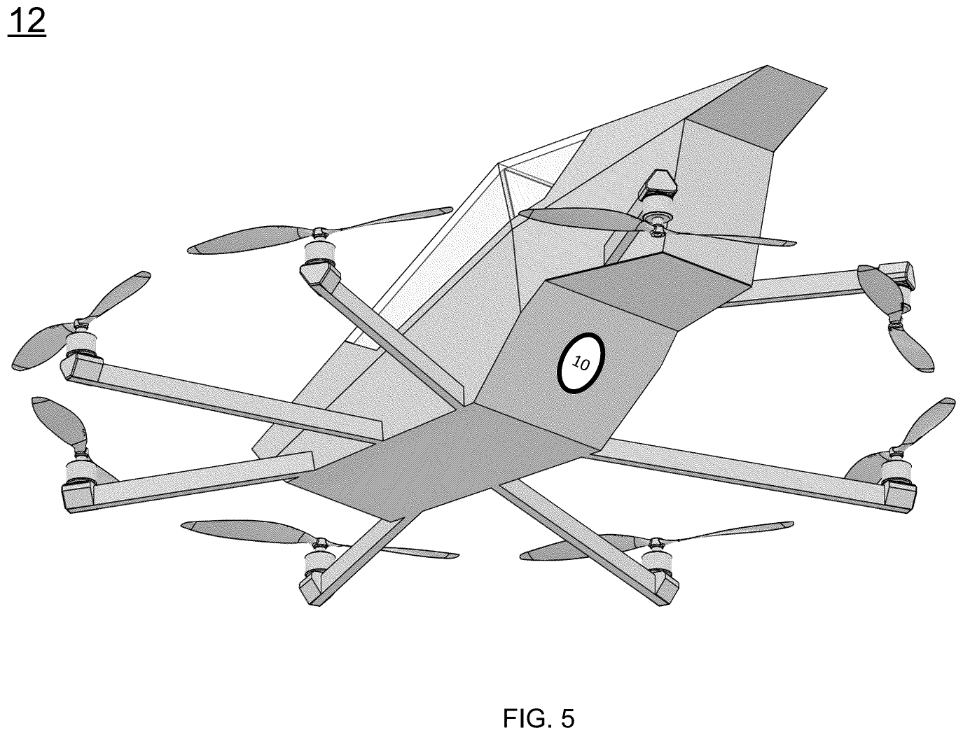

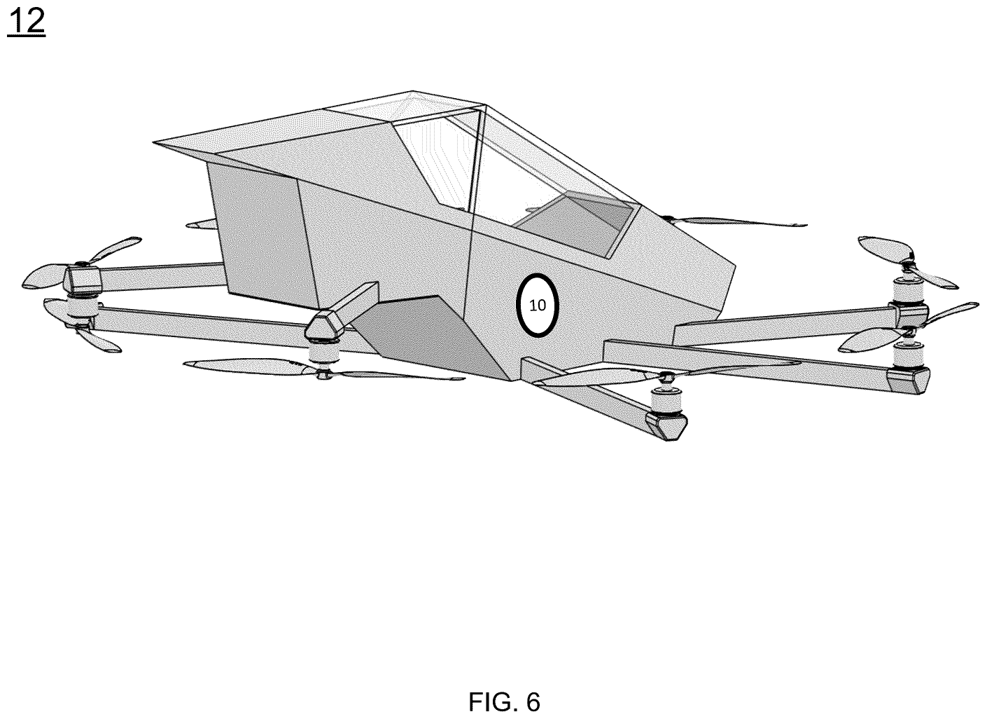

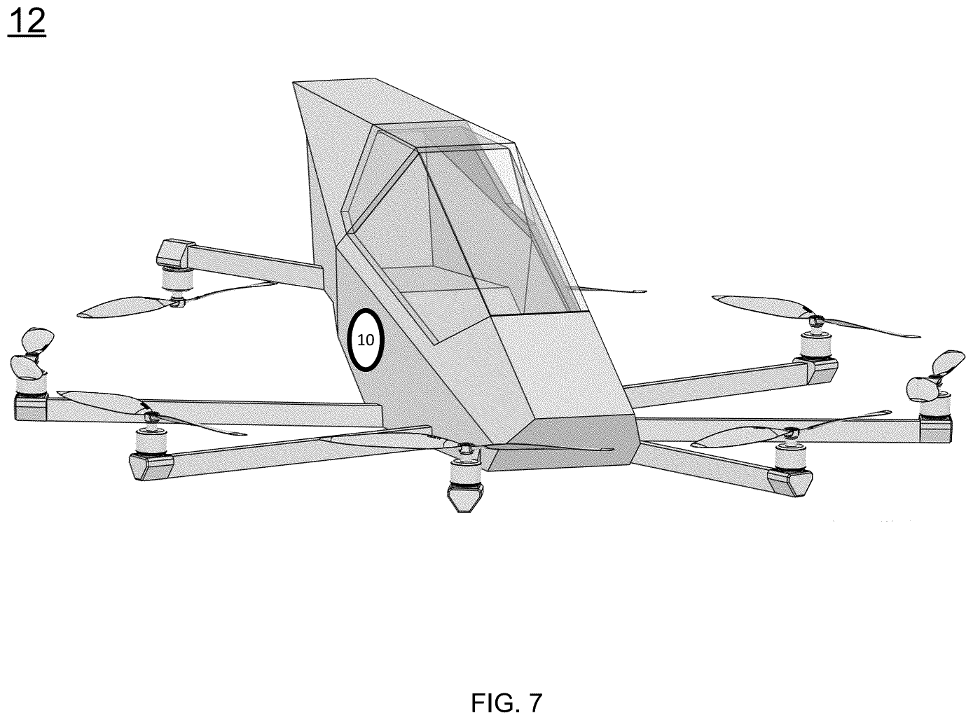

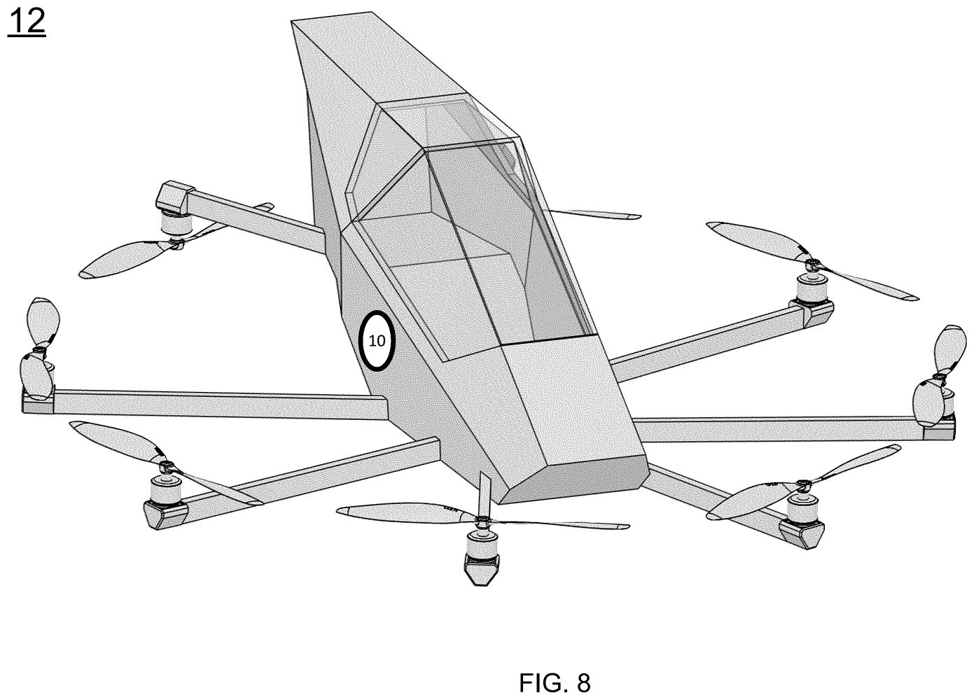

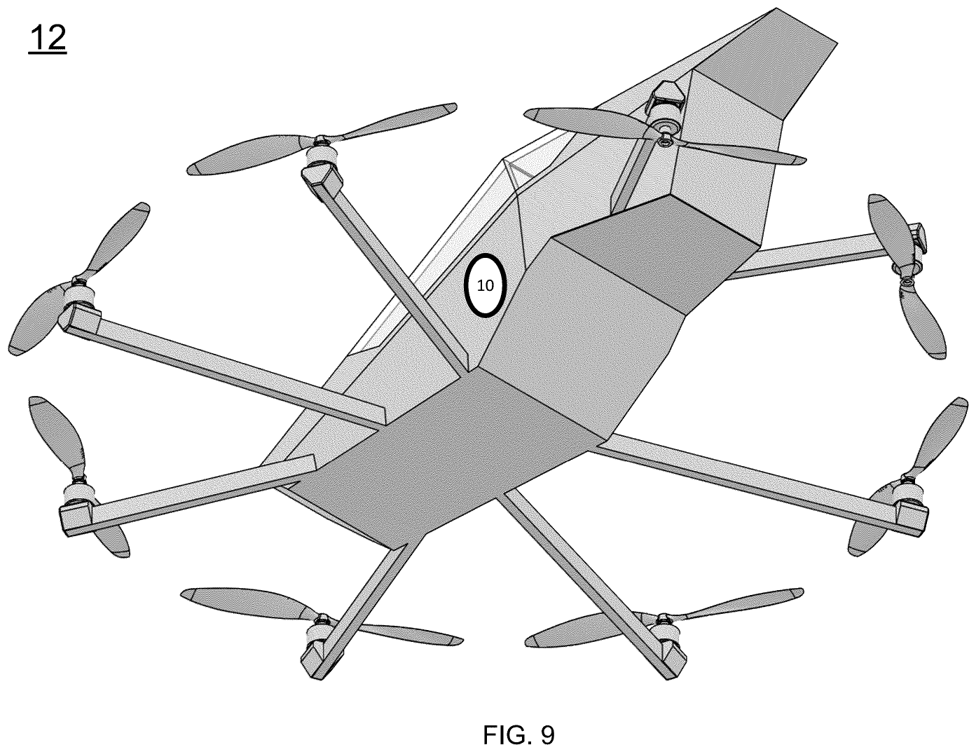

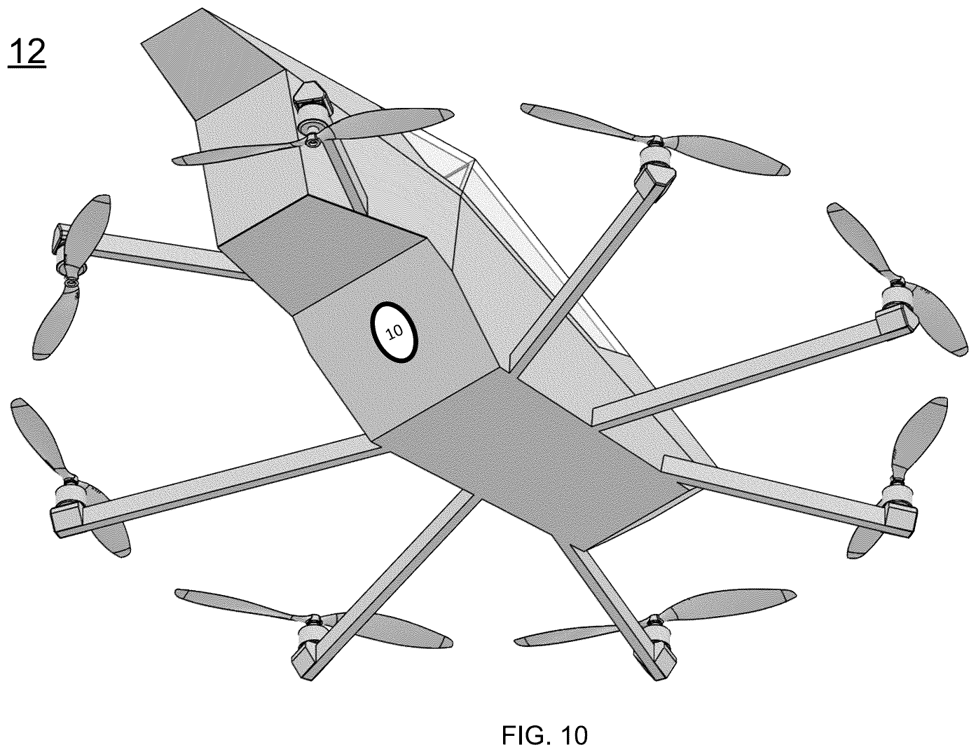

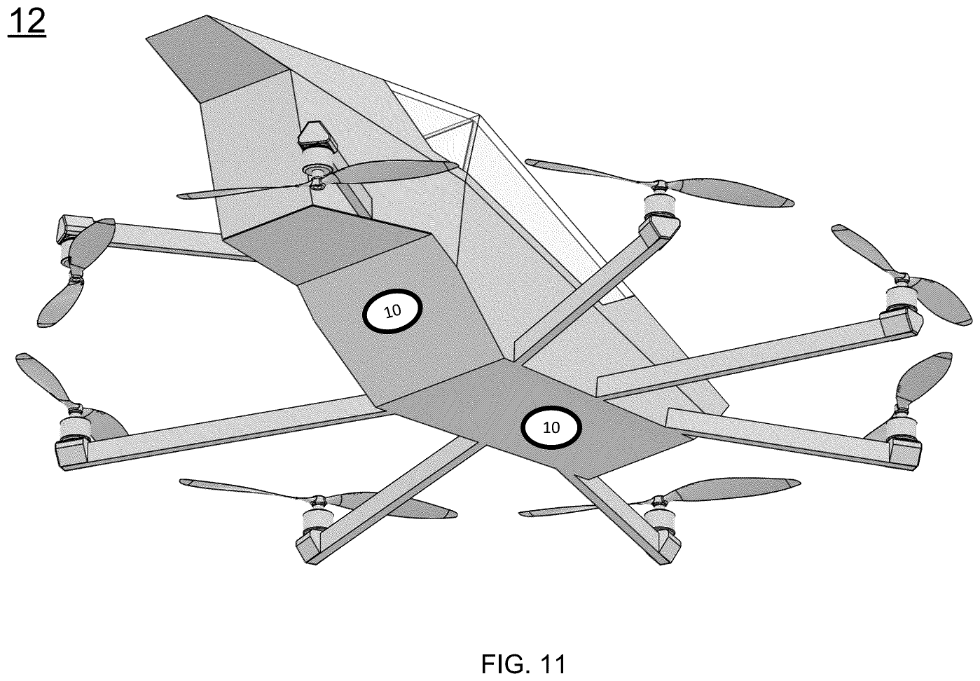

Referring to FIGS. 1-11, there is shown a quick-connection assembly (e.g., quick-connection assembly 10). Quick-connection assembly (e.g., quick-connection assembly 10) may be utilized on a unmanned aerial vehicle (e.g., UAV 12).

An unmanned aerial vehicle (e.g., UAV 12), commonly referred to as a drone, is an aircraft that operates without a human pilot onboard, using remote control, onboard computers, or artificial intelligence to navigate and execute tasks. UAVs come in a wide variety of sizes, designs, and configurations, ranging from small quadcopters and micro-drones used for recreational and commercial photography to large fixed-wing or hybrid aircraft employed for military, industrial, and scientific applications. Depending on their intended use, UAVs can be manually operated by ground-based pilots, autonomously guided via pre-programmed flight paths, or controlled using advanced artificial intelligence that allows for adaptive decision-making in real time.

UAVs (e.g., UAV 12) are typically equipped with various sensors, cameras, GPS navigation, and communication systems that enable them to perform a diverse range of tasks with high precision. They can carry payloads such as imaging equipment for aerial surveillance and reconnaissance, multispectral cameras for agricultural monitoring, LiDAR systems for topographical mapping, and cargo bins for logistics and supply delivery. Many UAVs also integrate additional technologies such as infrared sensors, radar, and AI-driven analytics to enhance their capabilities in complex environments.

These aerial systems are powered by different propulsion methods depending on their operational requirements. Small UAVs often use electric batteries for short-duration flights with minimal noise emissions, while larger UAVs may rely on internal combustion engines or hybrid propulsion systems to extend their range and endurance. Some advanced UAVs are even powered by solar energy or fuel cells, allowing for extended flight times in remote or high-altitude environments.

UAVs have transformed numerous industries by providing efficient, cost-effective, and safe alternatives to traditional manned aircraft. In agriculture, they are used for precision farming, crop monitoring, and pesticide spraying, reducing resource waste and increasing yields. In infrastructure and construction, UAVs assist in site surveys, structural inspections, and progress tracking. Emergency response teams rely on UAVs for search and rescue operations, disaster assessment, and medical supply delivery to inaccessible areas. In law enforcement and security, UAVs provide aerial surveillance, crowd monitoring, and reconnaissance capabilities, improving situational awareness. Militaries worldwide utilize UAVs for intelligence gathering, combat missions, target acquisition, and electronic warfare, enhancing operational effectiveness while minimizing risk to human personnel.

As UAV technology continues to evolve, advancements in artificial intelligence, machine learning, autonomy, and swarm coordination are expanding their capabilities even further. Future UAVs may feature enhanced endurance, improved sensor fusion, advanced communication networks, and greater integration with robotic systems, enabling more sophisticated and efficient aerial operations. With their versatility, adaptability, and growing role in automation, UAVs are set to play an increasingly critical role in the modern technological landscape across civilian, commercial, and defense applications.

Quick-connection assembly (e.g., quick-connection assembly 10) may include a first mechanical connector portion (e.g., first mechanical connector portion 14) configured to be coupled to a portion of an unmanned aerial vehicle (e.g., UAV 12).

For example and with respect to the portion of the unmanned aerial vehicle (e.g., UAV 12) to which the first mechanical connector portion (e.g., first mechanical connector portion 14) is coupled, the first mechanical connector portion (e.g., first mechanical connector portion 14) may be configured to be coupled to a panel assembly (e.g., panel assembly 16) of the unmanned aerial vehicle (e.g., UAV 12).

A panel assembly (e.g., panel assembly 16) of an unmanned aerial vehicle (e.g., UAV 12) refers to a structural or functional component of the UAV (e.g., UAV 12) that consists of interconnected panels forming part of the airframe, fuselage, or payload enclosure. These panels are typically designed to provide aerodynamic efficiency, structural integrity, and easy access to internal systems for maintenance, upgrades, or modular payload integration.

Panel assemblies can be constructed from lightweight, high-strength materials such as carbon fiber composites, aluminum alloys, or advanced polymers to optimize the UAV's weight-to-strength ratio while maintaining durability and resistance to environmental factors. Depending on their function, panels may be fixed or detachable, allowing for rapid component replacement, maintenance access, or customization based on mission requirements. For example, access panels provide entry points for servicing avionics, power systems, or propulsion components, while modular payload panels enable quick attachment of cameras, sensors, or weapon systems.

In larger UAVs, panel assemblies often include thermal insulation and electromagnetic shielding to protect sensitive electronics from extreme temperatures and electromagnetic interference. Additionally, stealth UAVs may feature radar-absorbing material (RAM) coatings integrated into their panel assemblies to reduce detectability. The design and configuration of a UAV's panel assembly (e.g., panel assembly 16) play a crucial role in aerodynamics, modularity, and operational efficiency, ensuring that the aircraft remains adaptable to a wide range of applications, from reconnaissance and logistics to combat and disaster response.

Further and with respect to the portion of the unmanned aerial vehicle (e.g., UAV 12) to which the first mechanical connector portion (e.g., first mechanical connector portion 14) is coupled, the first mechanical connector portion (e.g., first mechanical connector portion 14) may be configured to be coupled to a frame assembly (e.g., frame assembly 18) of the unmanned aerial vehicle (e.g., UAV 12).

A frame assembly (e.g., frame assembly 18) of an unmanned aerial vehicle (e.g., UAV 12) is the structural framework that supports and integrates all major components of the UAV, including the propulsion system, avionics, payloads, and control surfaces. It serves as the backbone of the UAV (e.g., UAV 12), ensuring mechanical integrity, stability, and durability while minimizing weight to optimize flight performance.

The frame assembly (e.g., frame assembly 18) is typically constructed from lightweight yet high-strength materials such as carbon fiber composites, aluminum alloys, titanium, or reinforced polymers, depending on the UAV's size, mission requirements, and operational environment. For small multirotor drones, the frame assembly (e.g., frame assembly 18) often consists of a central body with extended arms to hold motors and propellers, while larger fixed-wing UAVs have a fuselage-integrated frame with wing supports and reinforced mounting points for structural loads.

A well-designed UAV frame assembly (e.g., frame assembly 18) incorporates modularity, allowing for quick component replacements, upgrades, or payload customization. It also accounts for aerodynamic efficiency, vibration damping, and thermal management to enhance stability and performance in varying flight conditions. In military and industrial UAVs, the frame assembly (e.g., frame assembly 18) may include reinforced sections for rugged operations, stealth coatings for reduced radar cross-section, or shock absorption mechanisms for improved impact resistance. The UAV's frame assembly (e.g., frame assembly 18) plays a critical role in overall flight dynamics, endurance, and adaptability, making it a fundamental aspect of UAV (e.g., UAV 12) engineering and design.

Quick-connection assembly (e.g., quick-connection assembly 10) may include a second mechanical connector portion (e.g., second mechanical connector portion 20) configured to be coupled to an unmanned aerial vehicle accessory (e.g., UAV accessory 22).

The first mechanical connector portion (e.g., first mechanical connector portion 14) and the second mechanical connector portion (e.g., second mechanical connector portion 20) may be configured to be releasably mechanically couplable, thus enabling the unmanned aerial vehicle accessory (e.g., UAV accessory 22) to be releasably mechanically attachable to the unmanned aerial vehicle (e.g., UAV 12).

Examples of the first mechanical connector portion (e.g., first mechanical connector portion 14) and/or the second mechanical connector portion (e.g., second mechanical connector portion 20) may include but are not limited to one or more of: a hook and latch system; a magnetic fastener system; a suction cup mount system; a clamp and grip fastener system; a quick-release pin/fastener system; a rail and track mounting system; a threaded and bolt-on bracket system; and an interlocking/snap-fit system.

### Hook and Latch System

A hook and latch system, often referred to as a “Velcro” system, uses two complementary components: hooks (small, rigid elements) and loops (soft, flexible fibers). When the hook and latch surfaces are pressed together, the hooks catch the loops, creating a secure bond. In UAV applications, this system is commonly used to attach lightweight accessories or payloads that need to be attached quickly and securely but may require periodic detachment for reconfiguration or maintenance. It is simple to use, cost-effective, and allows for easy attachment and removal of accessories like cameras, sensors, or other payloads.

### Magnetic Fastener System

A magnetic fastener system uses magnets to securely attach accessories to a UAV (e.g., UAV 12). Magnets provide a strong yet non-permanent bond, making it easy to quickly attach and detach components without the need for complex tools or mechanical parts. This system is particularly useful for lightweight accessories such as cameras or external sensors that need to be rapidly swapped out depending on mission requirements. Magnetic systems also help reduce mechanical wear and tear since there are fewer moving parts involved in the attachment process.

### Suction Cup Mount System

A suction cup mount system utilizes vacuum suction to secure accessories to the UAV (e.g., UAV 12). The suction cup forms a tight seal on smooth, non-porous surfaces of the UAV's frame or panels. This system is ideal for lightweight, non-permanent attachments, such as cameras or environmental sensors, which need to be mounted on the UAV's exterior. The main advantage of this system is its versatility and ease of use, as it allows quick attachment and removal of accessories without causing damage to the UAV's structure.

### Clamp and Grip Fastener System

A clamp and grip fastener system uses mechanical clamps or grips to securely hold an accessory to the UAV (e.g., UAV 12). These clamps typically feature adjustable arms or levers that tighten around the accessory, ensuring a firm attachment. This system is ideal for heavier or bulkier payloads that require a more robust and secure mounting solution. It is commonly used in industrial, commercial, or military UAVs for attaching equipment like sensors, cameras, or specialized tools. The key benefit of the clamp and grip system is its ability to hold accessories securely under vibration or dynamic conditions.

### Quick-Release Pin/Fastener System

A quick-release pin or fastener system employs a spring-loaded pin that can be easily inserted and removed to attach or detach accessories from the UAV (e.g., UAV 12). This system is commonly used in situations where rapid deployment or retrieval of equipment is required, as it provides a secure and fast way to mount and dismount payloads. The pin is often manually operated or may feature a simple latch mechanism, making it a practical solution for military, industrial, or recreational UAV applications where time-sensitive tasks need to be performed without tools.

### Rail and Track Mounting System

A rail and track mounting system consists of a series of rails or tracks that provide a fixed and adjustable framework for attaching accessories to the UAV (e.g., UAV 12). Accessories are mounted onto these rails, either sliding into place or being fixed with locking mechanisms. This system allows for precise placement and easy repositioning of payloads along the rail. It may be used in UAVs designed for industrial or military purposes, where equipment such as cameras, sensors, or even weapons need to be mounted in a specific location on the drone for optimal performance.

### Threaded and Bolt-On Bracket System

A threaded and bolt-on bracket system involves using screws or bolts to attach accessories to the UAV (e.g., UAV 12). A threaded hole or nut is typically integrated into the UAV's frame or an attachment bracket, allowing the accessory to be secured with a bolt or screw. This system provides a highly secure attachment and is particularly useful for heavy-duty accessories that need to withstand significant forces or vibrations, such as high-end cameras, LiDAR systems, or payloads. While it provides a solid, stable mount, the system may require tools for attachment and detachment, making it less suitable for quick changes.

### Interlocking/Snap-Fit System

An interlocking or snap-fit system uses complementary, molded components that interlock or snap into place to securely attach accessories to a UAV (e.g., UAV 12). The accessory features protruding clips, tabs, or hooks that fit into corresponding slots or grooves on the UAV (e.g., UAV 12), forming a secure connection once engaged. This system may be used for smaller, modular accessories that need to be attached and detached frequently, such as modular sensors or cameras. The interlocking or snap-fit system is easy to use and provides a firm hold, making it ideal for applications requiring frequent reconfiguration of UAV payloads without the need for additional tools or fasteners.

The first mechanical connector portion (e.g., first mechanical connector portion 14) and the second mechanical connector portion (e.g., second mechanical connector portion 20) may be remotely decouplable. For example and when a first mechanical connector portion (e.g., first mechanical connector portion 14) and the second mechanical connector portion (e.g., second mechanical connector portion 20) are remotely decouplable in the context of detaching an accessory (e.g., UAV accessory 22) from an unmanned aerial vehicle (e.g., UAV 12), it means that the accessory (e.g., UAV accessory 22) can be disengaged or separated from the UAV (e.g., UAV 12) without requiring direct physical interaction by a human operator at the connection point. Instead, the decoupling process can be initiated through a remote signal, electronic command, or automated mechanism, allowing the UAV (e.g., UAV 12) to release or detach the accessory (e.g., UAV accessory 22) while in flight or from a distance.

This functionality is critical in various UAV applications where payloads or mission-specific attachments need to be deployed dynamically. For example, a cargo delivery UAV (e.g., UAV 12) might use a remotely decouplable system to drop a supply package in a disaster relief operation, or a surveillance drone may release a swarm of smaller UAVs mid-mission. Similarly, in military operations, a UAV (e.g., UAV 12) carrying an aerial deployment system could detach a rescue basket or a robotic unit in a hazardous environment without requiring the drone to land. The decoupling mechanism may rely on electromagnetic locks, servo-actuated latches, solenoids, or motorized release pins, all controlled remotely via the UAV's onboard control system or a ground operator. This feature enhances the UAV's operational flexibility, enabling it to quickly switch tasks or deploy critical payloads with precision while remaining airborne or stationed at a strategic location.

The unmanned aerial vehicle accessory (e.g., UAV accessory 22) may be configured to be utilized for one or more of: high voltage power line maintenance; firefighting; disaster relief; park-and-takeoff intelligence, surveillance, and reconnaissance; construction; contested logistics; agricultural spraying; personnel deployment; casualty evacuation; medical evacuation; drone swarm deployment; robotic systems testing; infrared/camera reconnaissance; anti-drone lasers; target lasing; and RF jamming.

### High Voltage Power Line Maintenance

UAVs play a crucial role in high-voltage power line maintenance by performing inspections, identifying faults, and even carrying out minor repairs without requiring human workers to climb dangerous infrastructure. Equipped with high-resolution cameras, LiDAR, and thermal imaging sensors, UAVs can detect insulation damage, corrosion, or overheating components. Some advanced UAVs also use robotic arms to clean power lines or replace small components, reducing the risk of electrocution and minimizing maintenance downtime.

### Firefighting

In firefighting operations, UAVs provide real-time aerial intelligence, helping crews locate hotspots and track fire spread, even in low-visibility conditions. They are often equipped with thermal imaging cameras to see through smoke and identify trapped individuals. Some UAVs are designed to carry and drop fire retardants or water over targeted areas, assisting in suppression efforts. Additionally, tethered drones provide continuous situational awareness by hovering over fire zones and relaying data to command centers.

### Disaster Relief

UAVs are invaluable in disaster relief efforts, providing rapid aerial assessments of affected areas, delivering critical supplies, and supporting search and rescue operations. Equipped with cameras and environmental sensors, they help emergency responders map damaged infrastructure and locate survivors. Cargo UAVs can transport medical supplies, food, and water to remote or inaccessible locations, ensuring faster aid delivery where ground access is limited.

### Park-and-Takeoff Intelligence, Surveillance, and Reconnaissance (ISR)

For intelligence, surveillance, and reconnaissance (ISR) missions, UAVs configured for park-and-takeoff operations can be pre-positioned in strategic locations and activated remotely when needed. These drones provide real-time battlefield intelligence, monitor enemy movements, and assess threats without requiring constant operator oversight. Long-endurance ISR UAVs are equipped with high-resolution cameras, radar, and signal intelligence tools, making them ideal for covert or persistent surveillance operations.

### Construction

In construction, UAVs improve efficiency by conducting aerial site surveys, monitoring progress, and performing structural inspections. With LiDAR and photogrammetry capabilities, they create 3D maps that help engineers plan and track developments. UAVs also enhance worker safety by inspecting hazardous structures, such as high-rise buildings or bridges, before human crews intervene. Heavy-lift drones can even transport tools and materials to hard-to-reach areas, reducing manual labor.

### Contested Logistics

UAVs designed for contested logistics deliver critical supplies such as ammunition, medical kits, and equipment to troops in combat zones where traditional supply lines are too dangerous. These UAVs use stealth technology, autonomous navigation, and swarm tactics to bypass enemy defenses. By reducing the need for manned resupply convoys, they help minimize risks to personnel and ensure sustained operations in hostile environments.

### Agricultural Spraying

Agricultural UAVs enhance farming efficiency by autonomously spraying fertilizers, pesticides, and herbicides with high precision. Using GPS and AI-driven sensors, these drones optimize spray coverage, reducing waste and preventing overuse of chemicals. UAVs also conduct aerial health assessments of crops using multispectral imaging, allowing farmers to detect plant diseases, nutrient deficiencies, and irrigation issues in real time.

### Personnel Deployment

UAVs designed for personnel deployment can transport small teams, such as special forces or emergency responders, into hard-to-reach or high-risk areas. Electric vertical takeoff and landing (eVTOL) UAVs serve as rapid deployment platforms, enabling quick insertions without relying on traditional helicopters. These UAVs are particularly useful for hostage rescue missions, disaster response, or evacuating stranded personnel.

### Casualty Evacuation

UAVs configured for casualty evacuation (CASEVAC) transport injured personnel from battlefields or disaster zones to medical facilities without requiring human pilots. These UAVs can be fitted with stretchers, vital sign monitoring systems, and autonomous navigation to ensure safe transport. By eliminating the need for ground-based ambulances in dangerous environments, UAVs improve survival rates and reduce response times for critical patients.

### Medical Evacuation

For longer-range transport of critical patients, UAVs used in medical evacuation (MEDEVAC) provide fast and efficient airlift capabilities. These drones can be equipped with pressurized compartments, life-support systems, and telemedicine interfaces that allow remote doctors to monitor patients during transit. In remote or combat zones, UAV-based MEDEVAC reduces the risk to human pilots while ensuring rapid medical intervention.

### Drone Swarm Deployment

Swarm UAVs operate in coordinated groups to execute missions such as reconnaissance, electronic warfare, or offensive strikes. A mothership UAV may carry and deploy multiple smaller drones, each equipped with specific sensors or payloads. These swarms can overwhelm enemy defenses, conduct distributed surveillance, or execute synchronized attacks on high-value targets, enhancing operational effectiveness without exposing human forces to danger.

### Robotic Systems Testing

UAVs support the development and testing of robotic systems by providing aerial monitoring, navigation assistance, and simulated battlefield conditions. They are used in military, industrial, and research applications to evaluate autonomous coordination between ground robots and airborne systems. UAVs equipped with AI-driven analytics help refine robotic behaviors, ensuring improved performance in real-world scenarios.

### Infrared/Camera Reconnaissance

Equipped with high-resolution optical and infrared cameras, reconnaissance UAVs provide critical intelligence by detecting movement, identifying hidden targets, and surveying landscapes in all lighting conditions. These drones are widely used for military surveillance, law enforcement, and environmental monitoring. Infrared capabilities allow them to detect heat signatures, making them effective for nighttime operations or locating people in disaster-stricken areas.

### Anti-Drone Lasers

UAVs equipped with high-energy laser systems serve as mobile counter-drone platforms, neutralizing hostile UAV threats. These systems use AI-based tracking to detect and engage enemy drones at long distances, disabling them without relying on kinetic weapons. Anti-drone laser UAVs are particularly valuable for protecting military bases, airports, and critical infrastructure from drone incursions.

### Target Lasing

Target-lasing UAVs designate high-value targets using laser designators, allowing precision-guided munitions to strike with extreme accuracy. These UAVs often work in coordination with fighter jets, artillery, or drone strike systems. By providing target illumination from a safe distance, they enhance the effectiveness of airstrikes and ground operations while minimizing collateral damage.

### RF Jamming

RF-jamming UAVs are used in electronic warfare to disrupt enemy communications, radar, and GPS signals. These UAVs emit powerful radio frequency interference, preventing adversaries from using their drones, command systems, or secure networks. They are deployed for counter-drone operations, battlefield signal denial, and cyber warfare missions, ensuring that enemy forces lose their ability to coordinate attacks or navigate effectively.

Each UAV application enhances mission capabilities across industries, from military and emergency response to agriculture and construction, by leveraging automation, precision, and rapid deployment.

Examples of the unmanned aerial vehicle accessory (e.g., UAV accessory 22) may include but are not limited to one or more of: a visible light camera; a thermal imaging camera; a lighting system; a weapon system; a laser system; a cargo bin/net; a cable-based deployment system; a rescue basket; a plurality of swarm drones; a fire retardant deployment system; and an aerosol discharge system.

### Visible Light Camera

A visible light camera is one of the most common UAV accessories, enabling high-resolution image and video capture for reconnaissance, mapping, inspections, and real-time monitoring. These cameras may feature zoom capabilities, gimbal stabilization, and AI-powered object tracking to enhance aerial surveillance and data collection. UAVs equipped with visible light cameras are widely used in security, search and rescue, environmental monitoring, and commercial applications such as cinematography and infrastructure inspections.

### Thermal Imaging Camera

A thermal imaging camera detects heat signatures, allowing UAVs to operate effectively in low-visibility conditions, such as at night, in smoke-filled environments, or through dense foliage. These cameras are essential for search and rescue missions, firefighting, wildlife monitoring, and security operations, as they can identify humans, animals, and overheated machinery or electrical components. Thermal imaging-equipped UAVs are also used in law enforcement for tracking suspects and in agriculture for assessing crop health through temperature variations.

### Lighting System

A UAV-mounted lighting system provides illumination for nighttime operations, search and rescue missions, or inspection tasks requiring additional visibility. These systems can include high-intensity LED spotlights or infrared illumination for covert night vision use. Lighting-equipped UAVs support emergency response teams by illuminating disaster zones, assist law enforcement in nighttime surveillance, and enable cinematographers to capture aerial footage in low-light environments.

### Weapon System

A UAV weapon system consists of mounted firearms, missiles, or non-lethal weapons designed for military or law enforcement applications. These systems may be used for precision strikes, target neutralization, or riot control, depending on the mission parameters. Weaponized UAVs operate autonomously or via remote control, often integrating advanced targeting systems such as laser guidance or AI-based threat recognition to enhance operational effectiveness while reducing risk to human personnel.

### Laser System

Laser systems on UAVs serve multiple purposes, including range finding, target designation, and counter-drone operations. A laser designator allows UAVs to “paint” targets for precision-guided munitions, while high-energy lasers can be used to disable enemy drones, missiles, or electronic systems. In civilian applications, UAV-mounted lasers assist in topographical mapping, infrastructure scanning, and environmental monitoring by providing accurate distance measurements.

### Cargo Bin/Net

A cargo bin or net is a UAV attachment designed for transporting goods, medical supplies, or equipment to remote or hazardous locations. These systems enable UAVs to conduct logistics missions, such as delivering aid during disaster relief efforts or supplying troops in contested areas. Depending on the UAV's payload capacity, cargo bins can be enclosed for secure transport or netted for easy deployment and retrieval of supplies.

### Cable-Based Deployment System

A cable-based deployment system allows UAVs to lower or retrieve payloads without landing, making them ideal for delivering supplies to confined or dangerous areas. These systems are commonly used in military and rescue operations, where rapid and precise payload delivery is necessary. They may also be applied in utility maintenance, such as lowering tools or sensors onto high-voltage power lines for inspection and repair.

### Rescue Basket

A UAV-equipped rescue basket enables aerial extraction of injured or stranded individuals from hazardous environments. These baskets are designed to be lightweight yet strong enough to carry human payloads, making them valuable in search and rescue missions, especially in areas where helicopters cannot operate. UAV-based rescue baskets can provide faster and more flexible evacuation in disaster-stricken regions, battlefields, or remote wilderness locations.

### Plurality of Swarm Drones

A UAV configured to deploy a plurality of swarm drones acts as a mothership, launching and coordinating multiple smaller UAVs for collective mission execution. Swarm drones can be used for surveillance, electronic warfare, search and rescue, or offensive military operations. These drones communicate and operate autonomously or semi-autonomously, using AI-driven coordination to enhance effectiveness in reconnaissance, area denial, or large-scale data collection.

### Fire Retardant Deployment System

A fire retardant deployment system allows UAVs to assist in firefighting efforts by carrying and dispersing flame-retardant chemicals over wildfires or urban fires. UAVs equipped with this system provide rapid response capabilities, especially in difficult-to-reach areas where conventional firefighting aircraft or ground crews face challenges. These systems improve precision in fire suppression while reducing risks to human firefighters.

### Aerosol Discharge System

An aerosol discharge system enables UAVs to disperse substances such as pesticides, disinfectants, or crowd-control agents over targeted areas. Agricultural UAVs use this system for precision spraying of crops, while public health agencies deploy them for disinfection in pandemic response efforts. In military or law enforcement applications, UAVs with aerosol systems can be used for riot control by dispersing non-lethal agents like tear gas over a controlled area.

Each of these accessories enhances the UAV's functionality, allowing it to perform specialized tasks across various industries, including military, law enforcement, agriculture, disaster response, and public safety.

Quick-connection assembly (e.g., quick-connection assembly 10) may include a first electrical connector portion (e.g., first electrical connector portion 24) configured to be coupled to the portion of the unmanned aerial vehicle (e.g., UAV 12). As discussed above and with respect to the portion of the unmanned aerial vehicle (e.g., UAV 12) to which the first electrical connector portion (e.g., first electrical connector portion 24) is coupled, the first electrical connector portion (e.g., first electrical connector portion 24) may be configured to be coupled to a panel assembly (e.g., panel assembly 16) of the unmanned aerial vehicle (e.g., UAV 12) and/or a frame assembly (e.g., frame assembly 18) of the unmanned aerial vehicle (e.g., UAV 12).

Quick-connection assembly (e.g., quick-connection assembly 10) may include a second electrical connector portion (e.g., second electrical connector portion 26) configured to be coupled to the unmanned aerial vehicle accessory (e.g., UAV accessory 22).

The first electrical connector portion (e.g., first electrical connector portion 24) and the second electrical connector portion (e.g., second electrical connector portion 26) may be configured to be releasably electrically couplable, thus enabling the unmanned aerial vehicle accessory (e.g., UAV accessory 22) to be releasably electrically attachable to the unmanned aerial vehicle (e.g., UAV 12).

The first electrical connector portion (e.g., first electrical connector portion 24) and/or the second electrical connector portion (e.g., second electrical connector portion 26) may be configured to provide electrical power to the unmanned aerial vehicle accessory (e.g., UAV accessory 22). Additionally/alternatively, the first electrical connector portion (e.g., first electrical connector portion 24) and/or the second electrical connector portion (e.g., second electrical connector portion 26) may be configured to provide one or more control signals to the unmanned aerial vehicle accessory (e.g., UAV accessory 22).

Power signals and control signals (e.g., signal 28) are two types of signals that facilitate the operation of accessories (e.g., UAV accessory 22) attached to unmanned aerial vehicle (e.g., UAV 12), though they serve different purposes.

Power signals are electrical signals that supply the necessary energy to operate the accessories (e.g., UAV accessory 22) attached to the UAV (e.g., UAV 12). These signals carry electrical power, typically in the form of voltage or current, from the UAV's power source (usually the main battery or a dedicated power system) to the accessories, such as cameras, sensors, lighting systems, or propulsion systems. The primary purpose of power signals is to ensure that accessories receive the required energy to function. For example, a visible light camera or a thermal imaging sensor may rely on power signals to operate their imaging systems, while a lighting system may need power signals to illuminate its LED lights. These power signals are often routed through specialized connectors or wiring that can handle specific voltage and current requirements for each accessory.

In contrast, control signals are electrical signals used to direct the operation or behavior of the attached accessories (e.g., UAV accessory 22). Rather than providing power, control signals send commands to the accessories to adjust their functionality, such as turning on or off, changing settings, or altering their position. For example, control signals could instruct a gimbal to adjust the camera's angle or control the movement of a robotic arm attached to the UAV (e.g., UAV 12). These signals are typically sent via communication protocols like PWM (Pulse Width Modulation), CAN bus, or UART, which convey instructions between the UAV's flight controller and the accessory. Control signals are critical for coordinating the behavior of UAV systems and accessories, enabling the operator to interact with the UAV (e.g., UAV 12) and adapt to changing mission requirements.

The main difference between power and control signals lies in their function: power signals deliver the energy required to operate the accessories (e.g., UAV accessory 22), while control signals manage the functionality and actions of those accessories (e.g., UAV accessory 22). Both types of signals are essential for the efficient and coordinated operation of a UAV (e.g., UAV 12), but they serve complementary roles-one supplying energy and the other providing instructions for use.

The first electrical connector portion (e.g., first electrical connector portion 24) and/or the second electrical connector portion (e.g., second electrical connector portion 26) may include one or more of: a JST GH connector; a QS8 connector; a serial bus connector; a parallel bus connector; a USB connector; and an RJ45 connector.

### JST GH Connector

The JST GH connector is a compact, lightweight, and reliable 1.25 mm pitch connector commonly used in UAVs for connecting flight controllers, sensors, and peripheral devices. It features a secure locking mechanism that prevents accidental disconnection due to vibrations, making it ideal for UAV applications. This connector supports signal and low-power connections, ensuring stable electrical coupling between UAV accessories like GPS modules, telemetry radios, or gimbals. Its quick-connect design allows for easy attachment and detachment while maintaining a firm electrical interface for consistent performance.

### QS8 Connector

The QS8 connector is a high-current, anti-spark connector designed for power applications, typically used in UAVs to connect high-capacity lithium battery packs to power distribution boards or electronic speed controllers (ESCs). Its robust construction allows for safe and efficient high-amperage transmission, which is crucial in high-performance drones requiring substantial power. The quick-connect nature of QS8 connectors facilitates rapid battery swaps, minimizing downtime while ensuring a stable electrical connection that can handle high surge currents without overheating or failure.

### Serial Bus Connector

A serial bus connector, such as those used in UART (Universal Asynchronous Receiver-Transmitter) or CAN (Controller Area Network) systems, enables data communication between UAV components like flight controllers, cameras, or telemetry modules. These connectors ensure efficient, sequential data transfer while using fewer wires than parallel connections, making them ideal for lightweight UAV applications. The quick-connection aspect of serial bus connectors allows easy attachment and detachment of accessories without disrupting the data stream, ensuring minimal latency and high reliability in mission-critical UAV functions.

### Parallel Bus Connector

Parallel bus connectors facilitate high-speed data transmission by transferring multiple bits simultaneously across multiple lines. While less common in modern UAVs due to weight and wiring complexity, they can be used for legacy systems or high-throughput data applications such as image processing modules. These connectors must be designed for precise alignment to maintain signal integrity. A quick-connection assembly (e.g., quick-connection assembly 10) for a parallel bus in UAVs would typically include a multi-pin locking mechanism, ensuring reliable coupling while allowing for rapid accessory swaps without risking misalignment or connection errors.

### USB Connector

A USB (Universal Serial Bus) connector is widely used in UAVs for data transfer, firmware updates, and peripheral connectivity, such as connecting cameras, storage devices, or ground station interfaces. USB connectors, such as USB-C or Micro USB, provide a quick and standardized method for coupling UAVs to accessories, enabling plug-and-play functionality. The advantage of USB in UAV applications is its ability to transmit both power and data efficiently. A well-designed quick-connection assembly (e.g., quick-connection assembly 10) using USB ensures a secure yet easily detachable interface that maintains signal integrity even in high-vibration environments.

### RJ45 Connector

The RJ45 connector, typically used for Ethernet connections, enables high-speed data communication between UAVs and external networking equipment such as routers, base stations, or payload control systems. When used in UAV applications, an RJ45 quick-connection assembly (e.g., quick-connection assembly 10) must account for strain relief and locking mechanisms to prevent disconnections caused by movement or vibrations. This connector is particularly useful in tethered drone systems or for high-bandwidth applications where reliable wired data transmission is required. Quick-connect solutions for RJ45 in UAVs may involve magnetic couplings or latch-based connectors that allow rapid attachment without compromising connectivity.

Each of these connectors plays a vital role in quickly and reliably coupling a UAV (e.g., UAV 12) to its accessories (e.g., UAV accessory 22), ensuring efficient power delivery, data transmission, and modular adaptability for various UAV operations.

### General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A quick-connection assembly comprising:
a first mechanical connector portion configured to be coupled to a portion of an unmanned aerial vehicle;
a second mechanical connector portion configured to be coupled to an unmanned aerial vehicle accessory;
wherein the first mechanical connector portion and the second mechanical connector portion are configured to be releasably mechanically couplable, thus enabling the unmanned aerial vehicle accessory to be releasably mechanically attachable to the unmanned aerial vehicle.

2. The quick-connection assembly of claim 1 wherein the first mechanical connector portion is configured to be coupled to a panel assembly of the unmanned aerial vehicle.

3. The quick-connection assembly of claim 1 wherein the first mechanical connector portion is configured to be coupled to a frame assembly of the unmanned aerial vehicle.

4. The quick-connection assembly of claim 1 wherein the first mechanical connector portion and/or the second mechanical connector portion includes one or more of:
a hook and latch system;
a magnetic fastener system;
a suction cup mount system;
a clamp and grip fastener system;
a quick-release pin/fastener system;
a rail and track mounting system;
a threaded and bolt-on bracket system; and
an interlocking/snap-fit system.

5. The quick-connection assembly of claim 1 wherein the first mechanical connector portion and the second mechanical connector portion are remotely decouplable.

6. The quick-connection assembly of claim 1 wherein the unmanned aerial vehicle accessory is configured to utilized for one or more of:
high voltage power line maintenance;
firefighting;
disaster relief;
park-and-takeoff intelligence, surveillance, and reconnaissance;
construction;
contested logistics;
agricultural spraying;
personnel deployment;
casualty evacuation;
medical evacuation;
drone swarm deployment;
robotic systems testing;
infrared/camera reconnaissance;
anti-drone lasers;
target lasing; and
RF jamming.

7. The quick-connection assembly of claim 1 wherein the unmanned aerial vehicle accessory includes one or more of:
a visible light camera;
a thermal imaging camera;
a lighting system;
a weapon system;
a laser system;
a cargo bin/net;
a cable-based deployment system;
a rescue basket;
a plurality of swarm drones;
a fire retardant deployment system; and
an aerosol discharge system.

8. The quick-connection assembly of claim 1 further comprising:
a first electrical connector portion configured to be coupled to the portion of the unmanned aerial vehicle;
a second electrical connector portion configured to be coupled to the unmanned aerial vehicle accessory;
wherein the first electrical connector portion and the second electrical connector portion are configured to be releasably electrically couplable, thus enabling the unmanned aerial vehicle accessory to be releasably electrically attachable to the unmanned aerial vehicle.

9. The quick-connection assembly of claim 8 wherein the first electrical connector portion and/or the second electrical connector portion are configured to provide electrical power to the unmanned aerial vehicle accessory.

10. The quick-connection assembly of claim 8 wherein the first electrical connector portion and/or the second electrical connector portion are configured to provide one or more control signals to the unmanned aerial vehicle accessory.

11. The quick-connection assembly of claim 8 wherein the first electrical connector portion and/or the second electrical connector portion includes one or more of:
a JST GH connector;
a QS8 connector;
a serial bus connector;
a parallel bus connector;
a USB connector; and
an RJ45 connector.

12. A quick-connection assembly comprising:
a first mechanical connector portion configured to be coupled to a portion of an unmanned aerial vehicle;
a second mechanical connector portion configured to be coupled to an unmanned aerial vehicle accessory, wherein the first mechanical connector portion and the second mechanical connector portion are configured to be releasably mechanically couplable, thus enabling the unmanned aerial vehicle accessory to be releasably mechanically attachable to the unmanned aerial vehicle; and
wherein the first mechanical connector portion is configured to be coupled to a panel assembly of the unmanned aerial vehicle.

13. The quick-connection assembly of claim 12 wherein the first mechanical connector portion and/or the second mechanical connector portion includes one or more of:
a hook and latch system;
a magnetic fastener system;
a suction cup mount system;
a clamp and grip fastener system;
a quick-release pin/fastener system;
a rail and track mounting system;
a threaded and bolt-on bracket system; and
an interlocking/snap-fit system.

14. The quick-connection assembly of claim 12 wherein the first mechanical connector portion and the second mechanical connector portion are remotely decouplable.

15. The quick-connection assembly of claim 12 wherein the unmanned aerial vehicle accessory is configured to utilized for one or more of:
high voltage power line maintenance;
firefighting;
disaster relief;
park-and-takeoff intelligence, surveillance, and reconnaissance;
construction;
contested logistics;
agricultural spraying;
personnel deployment;
casualty evacuation;
medical evacuation;
drone swarm deployment;
robotic systems testing;
infrared/camera reconnaissance;
anti-drone lasers;
target lasing; and
RF jamming.

16. The quick-connection assembly of claim 12 wherein the unmanned aerial vehicle accessory includes one or more of:
a visible light camera;
a thermal imaging camera;
a lighting system;
a weapon system;
a laser system;
a cargo bin/net;
a cable-based deployment system;
a rescue basket;
a plurality of swarm drones;
a fire retardant deployment system; and
an aerosol discharge system.

17. The quick-connection assembly of claim 12 further comprising:
a first electrical connector portion configured to be coupled to the portion of the unmanned aerial vehicle;
a second electrical connector portion configured to be coupled to the unmanned aerial vehicle accessory;
wherein the first electrical connector portion and the second electrical connector portion are configured to be releasably electrically couplable, thus enabling the unmanned aerial vehicle accessory to be releasably electrically attachable to the unmanned aerial vehicle.

18. The quick-connection assembly of claim 17 wherein the first electrical connector portion and/or the second electrical connector portion are configured to provide electrical power to the unmanned aerial vehicle accessory.

19. The quick-connection assembly of claim 17 wherein the first electrical connector portion and/or the second electrical connector portion are configured to provide one or more control signals to the unmanned aerial vehicle accessory.

20. The quick-connection assembly of claim 17 wherein the first electrical connector portion and/or the second electrical connector portion includes one or more of:
a JST GH connector;
a QS8 connector;
a serial bus connector;
a parallel bus connector;
a USB connector; and
an RJ45 connector.

21. A quick-connection assembly comprising:
a first mechanical connector portion configured to be coupled to a portion of an unmanned aerial vehicle;
a second mechanical connector portion configured to be coupled to an unmanned aerial vehicle accessory, wherein the first mechanical connector portion and the second mechanical connector portion are configured to be releasably mechanically couplable, thus enabling the unmanned aerial vehicle accessory to be releasably mechanically attachable to the unmanned aerial vehicle;
a first electrical connector portion configured to be coupled to the portion of the unmanned aerial vehicle; and
a second electrical connector portion configured to be coupled to the unmanned aerial vehicle accessory, wherein the first electrical connector portion and the second electrical connector portion are configured to be releasably electrically couplable, thus enabling the unmanned aerial vehicle accessory to be releasably electrically attachable to the unmanned aerial vehicle.

22. The quick-connection assembly of claim 21 wherein the first mechanical connector portion is configured to be coupled to a panel assembly of the unmanned aerial vehicle.

23. The quick-connection assembly of claim 21 wherein the first mechanical connector portion is configured to be coupled to a frame assembly of the unmanned aerial vehicle.

24. The quick-connection assembly of claim 21 wherein the first mechanical connector portion and/or the second mechanical connector portion includes one or more of:
a hook and latch system;
a magnetic fastener system;
a suction cup mount system;
a clamp and grip fastener system;
a quick-release pin/fastener system;
a rail and track mounting system;
a threaded and bolt-on bracket system; and
an interlocking/snap-fit system.

25. The quick-connection assembly of claim 21 wherein the first mechanical connector portion and the second mechanical connector portion are remotely decouplable.

26. The quick-connection assembly of claim 21 wherein the unmanned aerial vehicle accessory is configured to utilized for one or more of:
high voltage power line maintenance;
firefighting;
disaster relief;
park-and-takeoff intelligence, surveillance, and reconnaissance;
construction;
contested logistics;
agricultural spraying;
personnel deployment;
casualty evacuation;
medical evacuation;
drone swarm deployment;
robotic systems testing;
infrared/camera reconnaissance;
anti-drone lasers;
target lasing; and
RF jamming.

27. The quick-connection assembly of claim 21 wherein the unmanned aerial vehicle accessory includes one or more of:
a visible light camera;
a thermal imaging camera;
a lighting system;
a weapon system;
a laser system;
a cargo bin/net;
a cable-based deployment system;
a rescue basket;
a plurality of swarm drones;
a fire retardant deployment system; and
an aerosol discharge system.

28. The quick-connection assembly of claim 21 wherein the first electrical connector portion and/or the second electrical connector portion are configured to provide electrical power to the unmanned aerial vehicle accessory.

29. The quick-connection assembly of claim 21 wherein the first electrical connector portion and/or the second electrical connector portion are configured to provide one or more control signals to the unmanned aerial vehicle accessory.

30. The quick-connection assembly of claim 21 wherein the first electrical connector portion and/or the second electrical connector portion includes one or more of:
a JST GH connector;
a QS8 connector;
a serial bus connector;
a parallel bus connector;
a USB connector; and
an RJ45 connector.
